(19) United States
(12) Patent Application Publication
(10) Pub. No.: US 2026/0371091 A1
(43) Pub. Date: Nov. 19, 2026

(54) DEVICE FINGERPRINTING WITH RESILIENCY TO HARDWARE WARM-UP

(71) Applicant: Oregon State University, Corvallis, OR (US)

(72) Inventors: Abdurrahman Elmaghbub, Corvallis, OR (US); Bechir Hamdaoui, Corvallis, OR (US)

(73) Assignee: Oregon State University, Corvallis, OR (US)

(21) Appl. No.: 19/207,207

(22) Filed: May 13, 2025

(51) Int. Cl. H04W 12/40; G06N 3/045

(52) U.S. Cl. CPC H04W 12/40; G06N 3/045

(57) ABSTRACT

Example systems and methods for device fingerprinting with resiliency to hardware warm-up are described. One example method involves applying a neural network having a first component and a second component. The first component of the neural network is trained for estimating one or more impairment metrics. The second component of the neural network is trained to classify a wireless device based at least in part on output from the first component of the neural network. The method also involves receiving first information from a first wireless device. The method also involves identifying the first wireless device based on applying the neural network and using the first information.

### BACKGROUND

Device fingerprinting systems can be used to automate device identification and authentication through the extraction of hardware fingerprints. These fingerprints exist due to inherent device hardware imperfections introduced during the manufacturing of circuitry components. The hardware imperfections are typically random and differ from device to device. Thus, device fingerprinting systems can leverage hardware imperfections to determine unique device signatures to identify and distinguish devices from one another.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 illustrates a diagram of example In-Phase/Quadrature (I/Q) signal behavior observed at different times during an initial operation period of an example device.

FIG. 2A illustrates an example system that includes multiple transmitting devices.

FIG. 2B illustrates an example system that includes a software defined radio (SDR) in communication with a first transmitter via a wired connection and with a second transmitter via a wireless connection.

FIGS. 3A-B illustrate diagrams of example evaluations for training and testing an example device fingerprinting apparatus during warm-up intervals.

FIGS. 4A-B illustrate diagrams of example results of training and testing an example device fingerprinting apparatus during stable intervals.

FIGS. 5A-B illustrate diagrams of example results of training an example device fingerprinting apparatus on stable data captures and testing the example device fingerprinting apparatus on warm-up data captures.

FIGS. 6A-B illustrate example configurations of an example system used to collect hardware impairment measurements.

FIG. 7 illustrates diagrams of example hardware impairment metrics based on data collected from a plurality of devices during an initial thirty minutes of operation of the plurality of devices via a wired connection.

FIG. 8 illustrates diagrams of example hardware impairments of an example device based on measurements collected on different days.

FIG. 9 illustrates a system that includes an example network node device that implements an example device fingerprinting system to identify one or more wireless devices at different locations in an environment of the example network node device, according to at least some embodiments.

FIG. 10 illustrates a diagram of a machine learning model that can be used to perform device fingerprinting with resiliency to hardware warm-up by applying an example neural network that includes a first component that implements a pre-trained feature extractor and a second component that implements a device classifier, according to at least some embodiments.

FIG. 11 illustrates a flowchart of a process for sequential transfer learning of hardware impairment estimation to improve robustness of device classification, according to at least some embodiments.

FIG. 12 illustrates a flowchart of a process for sequentially training a first component of an example neural network for estimating one or more hardware impairment metrics and using features extracted by the pre-trained first component as input for training a second component of the example neural network to classify devices with resiliency to hardware warm-up, according to at least some embodiments.

FIG. 13 illustrates diagrams of hardware impairment metrics determined based on wireless data signals collected from a plurality of devices during an initial thirty minutes of operation of the plurality of devices.

FIG. 14 illustrates diagrams showing estimated hardware impairment metrics of a plurality of different devices using an example impairment estimator of an example device fingerprinting device.

FIGS. 15A-B illustrate diagrams showing performance of an example device fingerprinting system with resiliency to hardware warm-up as compared to performance of other device fingerprinting systems.

FIGS. 16A-B illustrate diagrams evaluating performance of an example device fingerprinting system when pre-trained to estimate various possible combinations of multiple hardware impairment metrics simultaneously to improve device classification.

FIG. 17 illustrates a computer system having machine-readable media with instructions for executing the scheme of various embodiments.

### DETAILED DESCRIPTION

Radio frequency (RF) fingerprinting works by identifying unique characteristics in signals that devices send out. These signals can be affected by tiny and/or natural imperfections in device hardware, which may occur during manufacturing. Even when two devices are of the same model, each individual device may have unique signal characteristics. However, when devices first start up (e.g., a period that may be referred to herein as the “warm-up” period) or when the devices transition from a sleep mode to an active mode, the devices may not necessarily send signals that are consistent with signals sent when the devices are operating in a stable period, e.g., after device components settle into a stable state, which could take several minutes or longer after start-up. The hardware warm-up period may prevent or delay systems that rely on RF fingerprinting from being able to accurately identify devices when they start up and/or transition from a sleep mode to an active mode. If a system is unable to recognize a device during the warm-up period, in at least one scenario, the system may be unable to operate efficiently or safely. For example, the system may misidentify a familiar device as a stranger and thus deny network services and/or access to the familiar device. Failure to accurately identify such devices may also lead to potential security issues or connectivity problems.

The inability to recognize devices accurately during their warm-up period can pose significant security risks including, e.g., in environments that include Internet of Things (IoT) devices. For example, some IoT devices, such as smart thermostats, security cameras, wearables, etc., often go into “sleep” mode to conserve energy and then “wake up” periodically to transmit data. Each time they wake up, they might undergo a brief warm-up period where their RF fingerprint is not as distinct or consistent as it is in a fully operational state. This inconsistency can lead to several security vulnerabilities. For instance, it could allow unauthorized devices to masquerade as legitimate ones during their indistinct warm-up phase, gaining access to restricted networks. As another example, hackers or other unauthorized entities could exploit this window to introduce malicious devices into the network, potentially leading to data breaches or disruptions in service.

Moreover, if legitimate devices fail to be recognized due to altered RF fingerprints during warm-up, the legitimate devices might be incorrectly flagged as security risks. This could lead to legitimate devices being repeatedly disconnected or blocked from the network, hampering functionality and reducing the reliability of the network. In critical environments where continuous monitoring and real-time data are vital, such as in healthcare or industrial settings, these disruptions could lead to more than just inconvenience. For example, these disruptions could potentially result in significant operational challenges or safety risks.

To that end, examples herein include methods for improving accuracy of identifying devices even during warm-up phases, which may be crucial in at least some applications such as for maintaining security and/or efficiency of networks populated with IoT devices.

There are several factors that may cause a distortion of the normal behavior of electronic components expected for accurate RF fingerprinting. As an example, there may be an inherent instability of electronic components as they heat up and stabilize, which may lead to fluctuations in RF emissions that are used for device fingerprinting. These variations can significantly alter an RF signature of a device temporarily, making it difficult to match against known profiles established under stable conditions. As another example, the warm-up phase can vary in duration not only between different types of devices but also between units of the same model due to slight variations in component manufacturing. This inconsistency adds another layer of complexity to designing systems that can reliably recognize devices quickly after the devices power on. As another example, environmental factors such as temperature and humidity can exacerbate the effects of hardware warm-up, further affecting the reliability of RF fingerprinting. For instance, these external conditions can alter the electrical properties of device components, thus influencing the RF signals emitted during the warm-up phase. Therefore, a more robust and/or accurate process for device fingerprinting is desirable.

One approach involves delayed authentication. In this approach, devices are not authenticated immediately upon boot-up. Instead, the system waits for the device to pass the warm-up phase before attempting RF fingerprinting. This delay can help improve the likelihood that the RF signature is stable and matches an expected profile more closely. In at least one embodiment, the delay in device authentication might reduce overall responsiveness and/or efficiency of a network. In scenarios where immediate device communication is crucial, such as in emergency medical systems or industrial automation, this delay may not be viable. Furthermore, in some scenarios, requiring IoT devices to remain active longer just to pass the warm-up phase before authentication is performed can significantly drain battery life. This may be problematic for devices in remote areas or applications where frequent maintenance is not feasible, for example. Furthermore, operational delays may be less suitable for some applications. For instance, in environments where devices need to react quickly upon activation, such as emergency response systems or critical infrastructure monitoring for example, waiting out the warm-up phase could delay important actions and/or data transmission, which could potentially lead to missed alerts or slow system responses. Furthermore, in some scenarios, delayed authentication may lead to increased exposure to vulnerabilities. For example, the longer a device remains unauthenticated, the greater the window of opportunity for potential security breaches. This period of vulnerability could potentially be exploited by attackers as well, especially if the device is communicating sensitive data or performing critical control functions.

Another approach involves utilizing an enhanced signal processing technique. In this approach, enhanced signal processing techniques are applied specifically to compensate for impairments that may vary during the warm-up phase, such as the Carrier Frequency Offset (CFO) and other oscillator-related impairments. These impairments are critical because they can significantly alter the RF fingerprint of a device. However, in some scenarios, this approach may be associated with reduced distinguishability. For example, CFO is often one of the most distinct features in stable phases, providing high distinguishability between devices. By compensating for CFO variations during the warm-up phase, there is a risk of ‘flattening’ these features, thus potentially reducing an overall effectiveness of the fingerprinting process. This compensation might also strip away nuances that are critical for distinguishing between devices that are otherwise very similar in their RF emissions. Furthermore, in some scenarios, this approach may be associated with increased complexity and/or resource requirements. For example, implementing dynamic compensation may require sophisticated algorithms that run on the IoT devices themselves or on a connected gateway. This could add computational overhead and/or increase power consumption, which is particularly problematic for battery-operated devices designed to function with minimal energy usage for example. Furthermore, in some scenarios, this approach may be associated with a trade-off between accuracy and efficiency. For example, while these techniques can improve the initial identification accuracy during the warm-up phase, they may require fine-tuning to balance the trade-off between maintaining distinctive features and achieving quick operational readiness. In general, the more aggressive the compensation technique employed, the higher the risk of overlooking subtle yet critical variations in the RF signals of the device.

Another approach involves using machine learning (ML) models trained with data from both the warm-up and stable phases. This approach involves training machine learning models to recognize devices based on a broader range of operational data, including the fluctuating data observed during the warm-up period. The goal is for the model to learn to identify the devices despite variations in their RF fingerprints caused by the warm-up effects. However, in some scenarios, this approach may be associated with feature loss. For example, during training, if the model is exposed to a significant amount of data from the warm-up phase, there is a risk that the trained model might start ignoring features that are stable and distinctive in the normal operational phase but appear variable during warm-up. This may happen because the model aims to generalize across all data, potentially leading to a loss of crucial distinguishing features that are stable outside of the warm-up period, for example. Furthermore, this approach may be associated with suboptimal classification accuracy. For example, some models trained to account for both the stable and warm-up phases could potentially result in compromised specificity. For instance, such models may achieve acceptable performance across different phases but fail to reach the high accuracies possible when trained and tested on stable-phase data alone. This broad training approach can also potentially dilute the ability of the model to sharply distinguish between similar devices (e.g., when subtle differences in the RF fingerprints are crucial for identification). Furthermore, this approach may be associated with increased model complexity and/or overfitting. For example, to adequately capture and adapt to the variability introduced during warm-up, such models may tend to become more complex. This complexity can lead to overfitting, for example, where the model performs well on training data (including nuances of warm-up variability) but poorly on unseen, real-world data. Overfitting in this context means that the model may be overly sensitive to minor fluctuations that don't necessarily correspond to different devices but rather to different operational states of the same device.

Some aspects of the present disclosure include an enhanced machine learning based scheme that overcomes these challenges while also improving device fingerprinting accuracy even during the warm-up period.

The challenges associated with RF fingerprinting during the hardware warm-up phase could potentially have far-reaching implications, affecting numerous sectors that rely on secure and efficient device authentication.

Some of these challenges relate to costs. Specifically, the inability to accurately recognize devices immediately upon startup due to RF fingerprint variability may introduce significant risks and/or costs such as security costs or operational inefficiency. For example, in sectors like banking, healthcare, and critical infrastructure, security breaches due to misidentified devices can lead to significant financial losses and damage to reputation. As another example, in industrial settings or smart homes, delays in device recognition can hinder operational efficiency, affecting productivity and user experience.

Other challenges may be specific to the various stakeholders confronting these problems, such as device manufacturers, network security professionals, software developers (e.g., artificial intelligence (AI) specialists), and so on. For example, with respect to device manufacturers, the quality and reliability of their products may directly depend on effective and secure device authentication. As another example, network security professionals may be tasked with ensuring that only authorized devices access networks, and thus these experts need reliable tools to manage and secure network access. As another example, software developers, AI specialists, and/or other professionals may be responsible for developing algorithms and systems that manage and enhance RF fingerprinting capabilities.

Potential beneficiaries of improved device fingerprinting accuracy during warm-up periods include consumers, such as individuals and businesses that rely on secure, efficient networks, stand to benefit greatly from improvements in device authentication technologies. Additionally, service providers, such as telecoms, cloud service providers, etc., typically offer connected services which may benefit from enhanced security and operational reliability. Additionally, regulatory bodies such as government and industry regulators tasked with enforcing security standards may benefit from more reliable identification technologies. As device authentication becomes more reliable, it can also spur the growth of IoT and smart device markets, particularly in areas previously hindered by security concerns. Additionally, products that can offer reliable device identification and authentication technology may have a competitive edge, thus attracting more customers concerned about security. Better solutions can also help users meet increasingly stringent regulations on data security and device authentication, reducing the risk of penalties. Reliable device recognition technologies can also catalyze further innovations in related fields, such as automated systems management, proactive security measures, etc.

To that end, aspects of the present disclosure include methods for enhancing RF fingerprinting technology to address the challenges of the warm-up period. Embodiments and examples described herein may mitigate direct and indirect costs associated with security breaches and/or operational inefficiencies as well as enhancing the overall trust in connected systems and devices, which could pave the way for broader adoption and innovation in fields like IoT and/or other technology-driven sectors.

Various embodiments describe a scheme for deep learning based device fingerprinting that leverages sequential transfer learning and targeted impairment estimation to enable accurate classification of wireless devices. An example system first trains a first component of a neural network to estimate one or more hardware impairment metrics. A second component of the neural network is then trained to classify the wireless devices by using features extracted from the pre-trained first component as input. This scheme addresses the various challenges described above and achieves various technical effects including high accuracy of device identification during warm-up periods. For example, the scheme achieves classification accuracies of up to 96% during the initial intervals of device operation. Other technical effects will be evident from the various embodiments and figures.

The embodiments may be understood more fully from the detailed description given below and from the accompanying drawings of various embodiments of the disclosure, which, however, should not be taken to limit the disclosure to the specific embodiments, but are for explanation and understanding only.

In the following description, numerous details are discussed to provide a more thorough explanation of embodiments of the present disclosure. It will be apparent, however, to one skilled in the art, that embodiments of the present disclosure may be practiced without these specific details. In other instances, well-known structures and devices are shown in block diagram form, rather than in detail, to avoid obscuring embodiments of the present disclosure.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, depending on design needs or preferences, may comprise one or more signals that may travel in either direction and may be implemented with any suitable type of signal scheme.

It is pointed out that those elements of the figures having the same reference numbers (or names) as the elements of any other figure can operate or function in any manner like that described but are not limited to such.

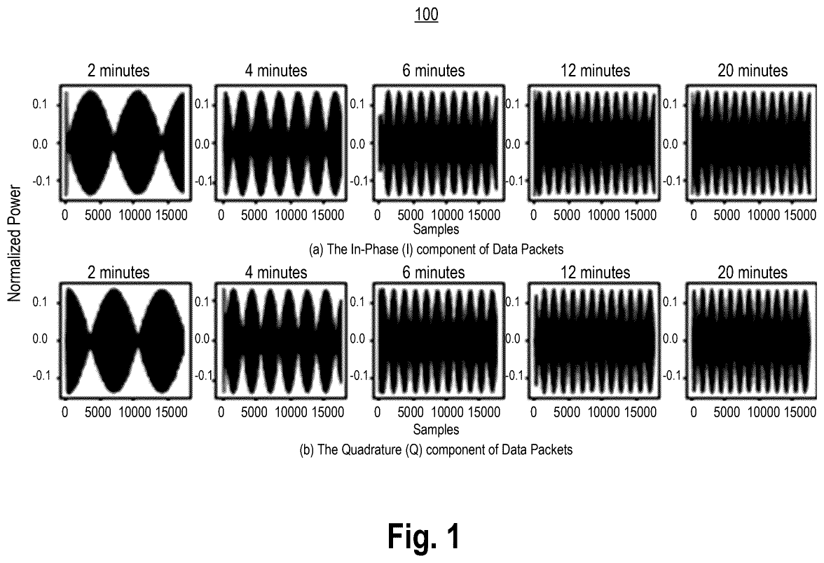

FIG. 1 illustrates a diagram 100 of example I/Q signal behavior observed at different times during an initial operation period of an example device (e.g., wireless transmitter, wireless transceiver, wireless device, etc.). FIG. 1 depicts time-domain I/Q representations of data frames (e.g., WiFi frames) captured at different intervals during the initial operation periods. The far-left figures represent signals recorded two minutes after device activation, while the far-right figures correspond to signals recorded at 20 minutes post-activation, and so forth. This illustration provides valuable insights into the alterations during the initial operation period. In the illustrated example, as the time-of-capture increases, both the I and Q shapes undergo changes, characterized by a frequency-increasing envelope in the signal over time. Notably, in this example, the I and Q signal components become more stable around the 12-minute mark from device activation, which we will refer to as the end of ‘warm-up’ period.

In at least one embodiment, alterations in signal characteristics observed during the warm-up period may be due to the complicated interplay of thermal effects on electronic components within RF devices. As these devices power on and initiate transmission, for example, a cascade of physical transformations may occur. An increase in temperature due to electrical activity may also trigger changes in the electrical and mechanical properties of critical components. For instance, because of thermal expansion and contraction of materials, oscillator resonance frequencies may drift, amplifier gains may fluctuate, and/or power supply output voltages may exhibit transient deviations. These thermal-induced variations may ripple through the RF signal path as well, introducing fluctuations in signal amplitude, phase, and frequency. Consequently, as shown, the transient alterations in the device RF emissions become particularly pronounced during this warm-up phase, as the electronic components strive to stabilize and reach their steady state operating conditions.

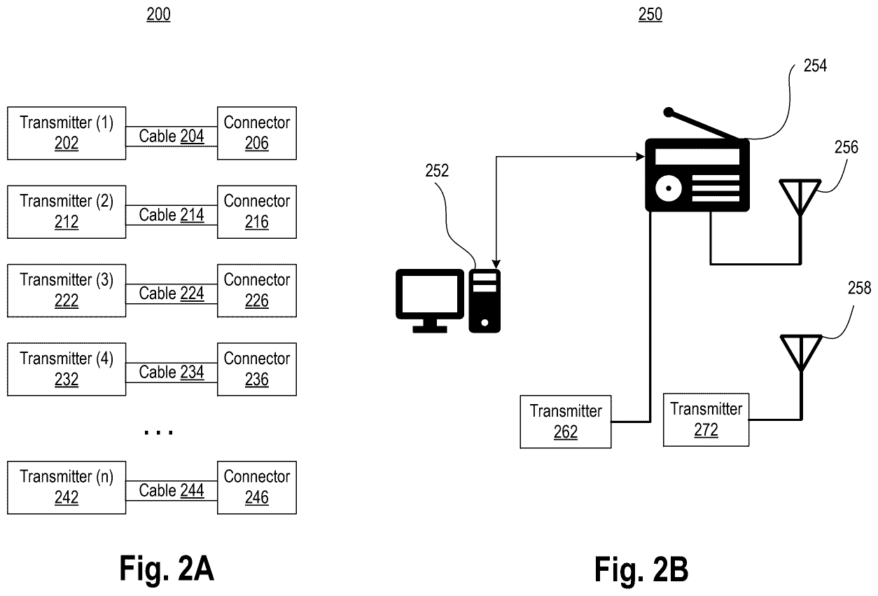

FIG. 2A illustrates a system 200 that includes multiple transmitting devices 202, 212, 222, 232, and 242. Devices 202, 212, 222, 232, and 242 may include any wireless device configured to receive and/or transmit data (e.g., PyCom transmitters, IoT devices, WiFi devices, etc.). Each transmitter is connected to a cable (e.g., coaxial cable) and a connector (e.g., RF connector) designed to maintain the shielding that the coaxial cables provide. As shown, for example, system 200 includes cables 204, 214, 224, 234, and 244 and connectors 206, 216, 226, 236, and 246.

FIG. 2B illustrates a system 250 that includes a software defined radio (SDR) 254 in communication with a first transmitter 262 via a wired connection and with a second transmitter 272 via a wireless connection. Transmitters 262 and 272 may be like transmitters 202, 212, 222, 232, 242, etc. SDR 254 may include any network subsystem with software defined radio and data collection capabilities. System 250 also includes a computing system 252, which may include any computer, server, or any other combination of hardware and software components configured to receive data captured by SDR 254. In at least one embodiment, computing system 252 is configured to execute a deep learning algorithm to process the captured data and perform example device classification processes of the present disclosure. In at least one embodiment, computing system 252 includes machine-readable media that stores instructions for classifying the various wireless devices 202, 212, 222, 232, 242, 262, 272, etc. Computing system 252 may include a local computer, a private server, a cloud computing device, a distributed system, etc. In the illustrated example, transmitter 262 communicates with SDR 254 via a wired connection, and transmitter 272 communicates with SDR 254 via a wireless connection (e.g., using antennas 256 and 258).

In at least one embodiment, SDR 250 includes a receiver (e.g., USRP B210 receiver, etc.) synchronized with an external oscillator (e.g., oven-controlled crystal oscillator (OCXO), etc.) for improved sampling accuracy and stability. In this example, devices 202, 212, 222, etc. may be powered via a USB from a computer and configured to transmit IEEE802.11b WiFi packets (or other data packets) using high-rate direct sequence spread spectrum (HR/DSSS) physical layer mode. For instance, the devices may transmit the packets at a rate of 1 Mbps with a carrier frequency of 2.412 GHz and a bandwidth of 20 MHz, e.g., while connected to an antenna like antenna 258 (e.g., ½ Wave Whip antenna or any other antenna). Other configurations of transmitters 202, 212, 222, 232, 242, 262, 272, etc. are possible as well.

In at least one embodiment, signals captured by SDR 254 and processed by computing system 252 according to this configuration may be digitally down-converted to a baseband and stored as I/Q samples (e.g., on computing system 252). This data collection process may include signals captured during the warm-up period of the transmitters (e.g., first ten minutes, etc.) as well as during stable periods of the transmitters (e.g., after ten minutes, etc.). The collected data is processed and presented as described in the following Figures.

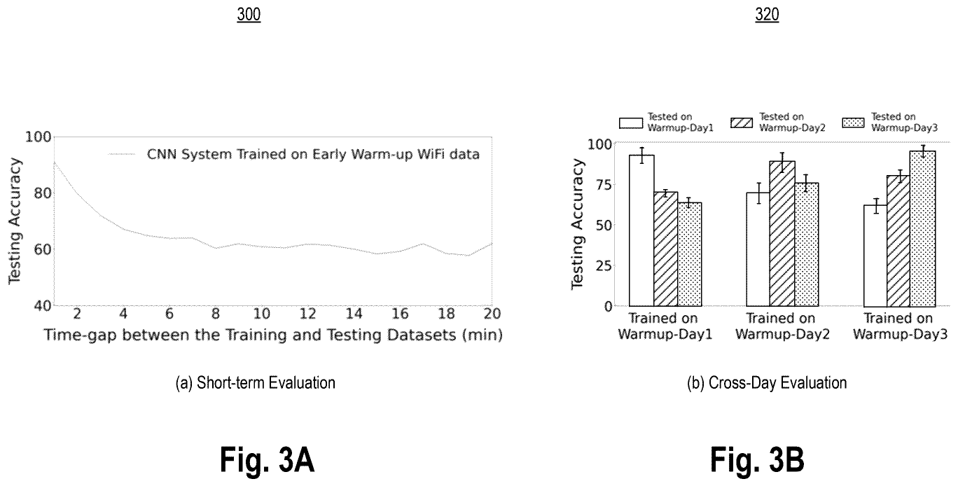

FIGS. 3A-B illustrate diagrams 300 and 320 of example evaluations for training and testing an example device fingerprinting apparatus (e.g., system 250) during warm-up intervals. In the scenario of FIGS. 3A-3B, a system (e.g., computing system 252) is configured to implement a convolutional neural network (CNN) trained with frames captured during the initial 2 minutes during the warm-up period to identify the wireless devices, and then the trained CNN is tested using frames captured at different minutes within the warm-up period and frames captured during the same period across three days. As shown in FIG. 3A (short-term scenario), the testing accuracy is measured for frames captured at different time-gaps between collection of the training data (e.g., warm-up phase training data) and collection of training data.

As depicted in FIG. 3A, the testing accuracy when trained on early warm-up data and tested across successive 20-minute intervals decreases as the time-gap increases. This marked decrease, particularly pronounced in the initial stages post-training, underscores the dynamic nature of signal characteristics during the warm-up phase, a phenomenon further confirmed by the observations in FIG. 1. The diminishing rate of accuracy decline, stabilizing towards the end of the warm-up phase, may suggest a gradual approach to signal consistency.

Moreover, as depicted in FIG. 3B, cross-day testing reveals a substantial average accuracy drop of 30%, which may indicate that the transient signal behavior during the warm-up phase significantly contributes to cross-day performance degradation of device fingerprinting according to this configuration as well. This analysis indicates that careful consideration is recommended when using warm-up period data for training, to mitigate the inherent instability and ensure more reliable RF fingerprinting performance.

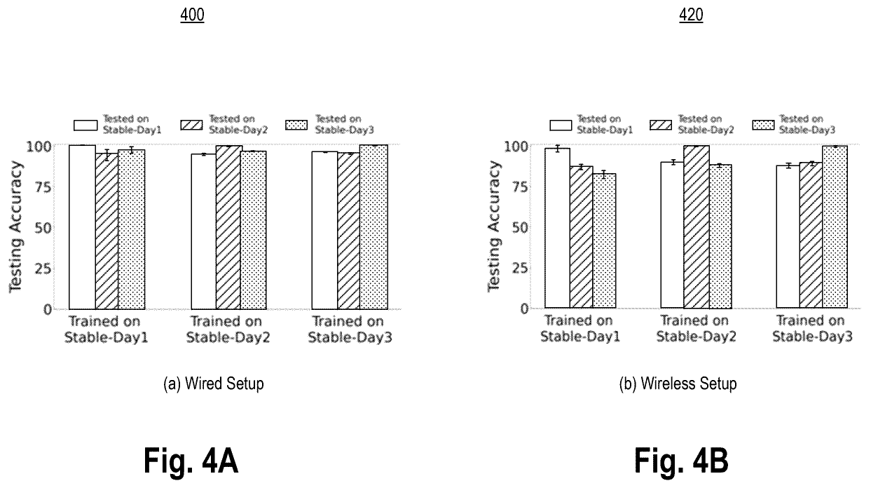

FIGS. 4A-B illustrate diagrams 400 and 420 of example results of training and testing an example device fingerprinting apparatus during stable intervals. In the scenario of FIGS. 4A-4B, a CNN of system 250 is trained using data packets collected during stable period, e.g., by training the system on stable data collected after hardware stabilization (e.g., after 12 minutes from device activation). The trained system is then tested with data packets that were also captured during stable periods (e.g., stable frames captured across three different days in both wired and wireless settings). By training and testing using data collected in stable periods, FIGS. 4A-4B can be used to determine whether varying signal characteristics associated with warm-up periods are an important contributor to performance degradation (e.g., same-day and/or cross-day scenarios). Additionally, testing both wired and wireless setups allows for quantifying the impact of wireless channels (e.g., distortions associated with environmental factors such as device position and/or obstructions between the transmitter antenna and the SDR antenna).

In the scenario of FIG. 4A (wired setup), the CNN model achieves exceptional performance when both training and testing are conducted on data collected after the device hardware has stabilized. The cross-day testing accuracy remains impressively high, with an average drop of only 4.4% when compared to same-day testing. This result indicates that the model can consistently classify devices in the wired environment, even when facing temporal variations across days. The minimal performance drop in the wired setting may indicate, for example, that the main driver of cross-day sensitivity could be due to the transient behavior of signals during the warm-up period.

In the scenario of FIG. 4B (wireless setup), the CNN model seems to exhibit strong performance when trained and tested on stable captures as well, showcasing an average cross-day testing accuracy of approximately 87.5%. Although this accuracy is slightly lower than the wired performance of the scenario of FIG. 4A (e.g., which may be due to the additional challenges posed by the wireless channel), the difference in performance between the wired and wireless setups (e.g., approximately 12% performance drop in wireless environment) is not as significant as the difference in performance associated with the data packets collected during the warm-up period (e.g., scenarios of FIGS. 3A-3B).

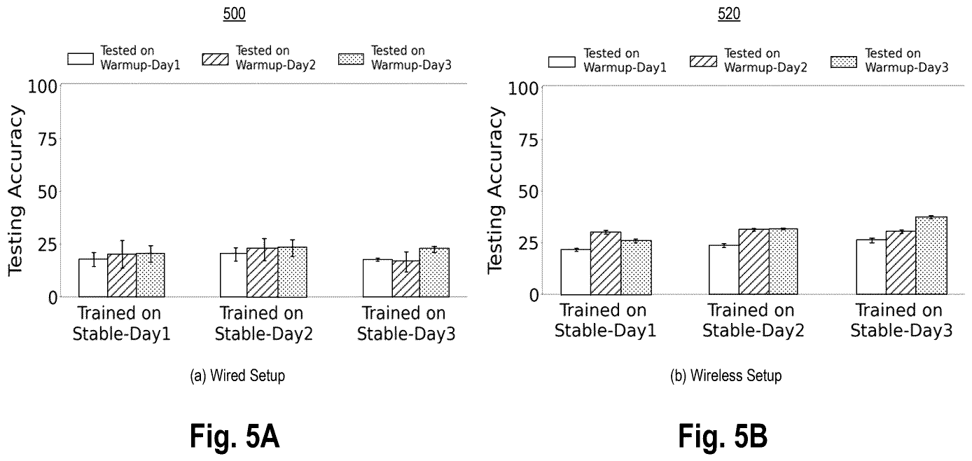

FIGS. 5A-5B illustrate diagrams 500 and 520 of example results of training an example device fingerprinting apparatus on stable data captures and testing the example device fingerprinting apparatus on warm-up data captures. In the scenario of FIGS. 5A-5B, a CNN of system 250 is trained using data packets collected during stable period, e.g., by training the system on stable data collected after hardware stabilization (e.g., after 12 minutes from device activation). The trained system is then tested with data packets that were captured during warm-up periods (e.g., within the first two minutes after device activation). Thus, the scenario of FIGS. 5A-5B can be used to evaluate performance of a CNN trained using data collected during stable periods when used identify devices based on data collected during warm-up periods.

As shown in FIGS. 5A-5B, the results of both the wired and wireless setups indicate poor accuracy of the classifier when trained on stable captures but tested on early warm-up data, with accuracy declining to as low as 17.8%. This stark decline in accuracy, consistent across both wired and wireless settings and exacerbated in cross-day scenarios, underscores device detection accuracy challenges associated with using data collected during the warm-up phase.

As noted earlier, the present disclosure describes a proposed scheme to overcome this limitation to improve device detection when data is collected during the warm-up phase or the stable phase. To facilitate this, an example system includes a neural network having a first component trained for estimating one or more hardware impairments, and a second component trained to classify wireless devices based at least in part on features extracted from the first component.

RF fingerprints are distinct patterns embedded in RF signals due to impairments and process-induced characteristics of RF hardware components. During a device warm-up period, manufacturing variations, electronic component tolerance, and/or other hardware-related imperfections jointly cause unique patterns in transmitted RF signals which can be used to extract fingerprints that distinguish between different devices. Thus, hardware-induced imperfections may influence the emergence of certain patterns in the transmitted RF signals. As such, a more nuanced analysis and consideration of such impairments in accordance with the present disclosure may facilitate improving accuracy of device detection during the warm-up phase. A non-exhaustive list of example hardware impairment metrics is described below, one or more of which can be measured and used to improve the device classification process.

Error Vector Magnitude (EVM) is a metric that quantifies a root-mean-square (RMS) value of an error vector at symbol clock transitions. It represents the RMS of differences between received symbol locations and their closest ideal locations in the constellation diagram, making it a pivotal metric for assessing modulation quality in digital communications. Mathematically, EVM can be expressed as EVM[k]=\sqrt{Iₑᵣᵣ[k]²+Qₑᵣᵣ[k]²}, where k is the symbol index, Iₑᵣᵣ=I_{ref}−Iₘₑₐₛᵤᵣₑ is the In-Phase (I) error, and Qₑᵣᵣ=Q_{ref}−Qₘₑₐₛᵤᵣₑ=is the Quadrature (Q) error. As an error metric, EVM quantifies a combined impact of potential impairments on the transmitter chain such as IQ imbalance, Phase noise, non-linearity, and frequency error. While the error vector has a phase value associated with it, in at least one embodiment, this angle may generally be random because it is a function of both the error itself (which may or may not be random) and a position of a data symbol on the constellation (which may be random).

Magnitude Error (e.g., as a standalone parameter) is a metric that quantifies deviation between the amplitude (magnitude) of a received signal and an ideal magnitude (or reference magnitude) of a signal constellation point. For instance, the magnitude error may indicate an amplitude accuracy of a signal. Magnitude Error may be represented as a percentage or in decibels (dB) and can be calculated as IQ_{Mag_error}[n]=|IQ_{ref}[n]|−|IQₘₑₐₛᵤᵣₑ[n]|.

Phase Error (e.g., as a standalone parameter) is a metric that characterizes a phase deviation between a received signal and an ideal reference signal. The phase error metric quantifies an angular error between an actual phase and an ideal phase of a signal constellation point and is usually expressed in degrees or radians. The phase error can be calculated as IQ_{phase_error}[n]=∠IQ_{ref}[n]−∠IQₘₑₐₛᵤᵣₑ[n].

IQ Offset is another example of hardware impairment metric. As communication systems extensively utilize modulation schemes to encode information onto carrier signals for transmission, accurate alignment of I and Q signal components may improve signal reception. IQ offset (and/or origin IQ offset) is a metric that quantifies a misalignment or deviation of the IQ origin from its intended position, which may be represented as a constant DC offset or carrier feedthrough in the modulated signal. The IQ offset may arise due to imperfections in hardware components, such as imbalances in the analog and digital processing chains, for example. In at least one embodiment, the IQ Offset metric may indicate magnitude of a carrier feedthrough signal. When there is no carrier feedthrough, IQ offset is zero (−infinity dB). The IQ offset metric can be calculated by RMS averaging a measured IQ offset for each symbol in a measurement interval and can be expressed relative to an average signal power. In some examples, an IQ offset can be caused when a center (DC) carrier leaks into the signal. In some examples, the IQ offset can additionally or alternatively be caused when a baseband signal has a DC offset which then shows up as a (DC) carrier power when the baseband signal is up-converted.

Carrier Frequency Offset (CFO) is another example of hardware metric. CFO is a parameter in modulation analysis and communication system performance evaluation. For instance, CFO quantifies a frequency error corresponding to deviation of a carrier frequency from its intended or nominal value. This offset can result from various factors such as, e.g., inaccuracies in local oscillator or frequency synthesis components, Doppler shifts in wireless channels, and/or environmental conditions affecting the carrier frequency. Errors in RF frequency, LO frequency, and/or digitizer clock rate can also appear as carrier frequency errors.

Symbol or chip clock error (SCE), also known as timing error, is another example of hardware impairment metric and is typically a parameter in modulation analysis (e.g., in digital communication systems). This error refers to a deviation in timing of a received signal from an expected or nominal symbol or chip clock timing. The symbol clock represents timing at which symbols are transmitted or received. In the context of spread spectrum systems, “chip” may refer to a basic signaling unit. SCE can be calculated by averaging symbol timing corrections during a measurement interval. In at least one embodiment, SCE is presented using parts-per-million (ppm) units.

Carrier Suppression Error (CSE) is another example of hardware impairment metric. When an information signal in the up-conversion stage of a transmitter modulates an RF carrier, some of the RF carrier signals may leak through the mixer and appear at the transmitter output. RF carrier suppression error or CSE measures RF carrier leakage relative to a modulated output signal. Measurement of RF carrier suppression is often expressed in decibels relative to a modulated signal. CSE may provide a quantitative assessment of the suppression level.

Average burst power is another example of hardware metric. Average burst power can be used as a power metric in various WLAN measurement applications. For example, the average burst power metric may represent a time-averaged power level of an 802.11 WiFi packet throughout the duration of a burst. In at least one embodiment, the average burst power metric may provide a comprehensive assessment of signal strength during transmission intervals.

It is noted that the example hardware metrics described above are only for the sake of example. In various embodiments, fewer or more or different hardware metrics can be measured, without departing from the scope of the present disclosure.

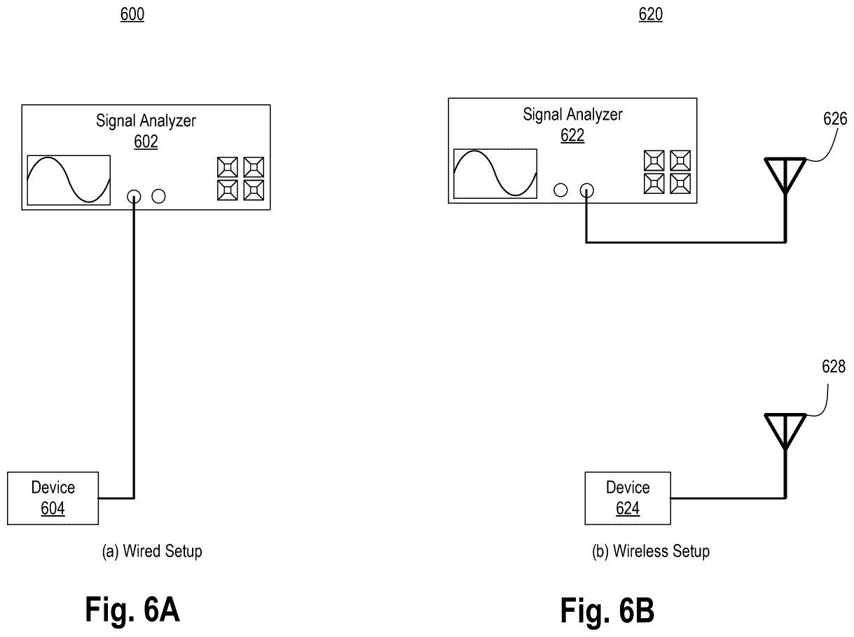

FIGS. 6A-6B illustrate configurations of systems 600 and 620 used to determine hardware impairment measurements using signals received from devices 604 and 624, in accordance with at least one embodiment. Devices 604 and 624 may include any wired or wireless devices configured to transmit information signals. In at least one embodiment, devices 604 and 624 may be like any transmitter devices 202, 212, 222, 232, 242, 262, or 272. Signal analyzers 602 and 622 are computing systems that can include any combination of hardware or software components (e.g., SDR, WLAN 802.11b measurement application, etc.) configured to analyze signals received from devices 604 and/or 624. For example, signal analyzers 602 and 622 may be configured to extract an IQ signal for a data packet (e.g., WiFi packet, other data packet, etc.) received from a device (e.g., devices 604 and/or 624). As another example, the signal analyzer(s) may also compute one or more of the hardware impairment metrics described above (e.g., EVM, magnitude error, phase error, IQ offset, CFO, SCE, CSE, average burst power, etc.) using the sampled IQ signal and/or other signal characteristics of the data packet. In the scenario of FIG. 6A (e.g., wired setup), signal analyzer 602 is connected to device 604 via a wired connection. In the scenario of FIG. 6B (e.g., wireless setup), signal analyzer 622 is wirelessly connected to device 624 via antennas 626 and 628. Antennas 626 and 628 may include any type of antenna (e.g., like antennas 256, 258, etc.).

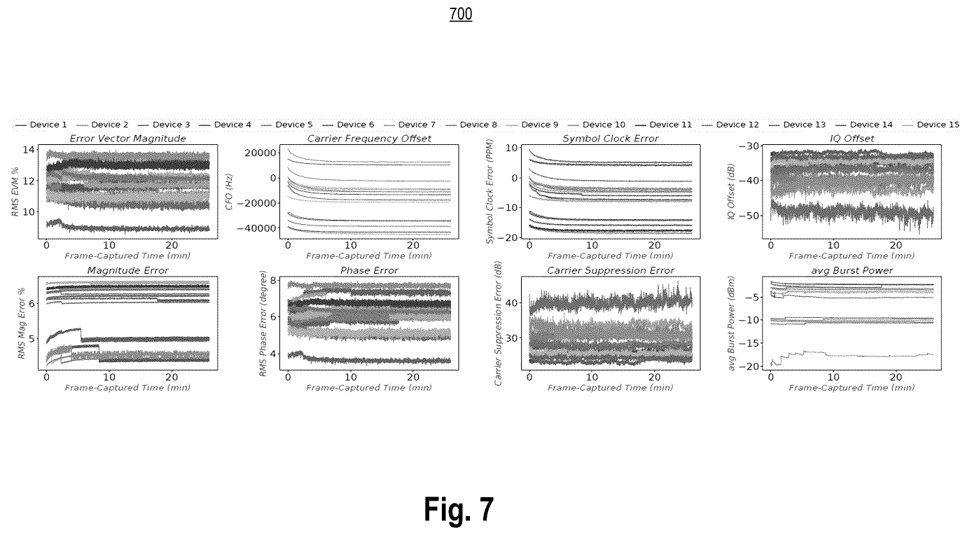

FIG. 7 illustrates diagrams 700 of example hardware impairment metrics measured based on data collected from a plurality of devices (e.g., 15 devices) during an initial thirty minutes of operation of each of the plurality of devices via a wired connection. For example, the measurements in FIG. 7 can be collected using system 600. However, in at least one embodiment, it is noted that the hardware impairment metrics can alternatively be measured using a wireless setup, such as the setup of system 620, for example.

In the example scenario of FIG. 7, signal analyzer 602 may be configured to measure the hardware impairment metrics for each RF burst corresponding to a data packet (e.g., WiFi 802.11b packet, etc.) transmitted from device 604. For instance, device 604 may be configured to transmit identical data packets at fixed intervals as the RF bursts. Simultaneously, in this scenario, signal analyzer 602 may be configured to sample incoming RF bursts, e.g., at a rate of 35 MSps (or any other rate) and at a bandwidth of 20 MHz (or any other bandwidth). In at least one embodiment, device 604 may also be configured to send measurements (e.g., reference values, etc.) needed to compute one or more specific hardware metrics (e.g., magnitude error, phase error, etc.). In the scenario of FIG. 7, this process is then repeated to measure hardware impairments of fifteen different devices.

As illustrated in FIG. 7, the hardware impairment metrics indicate a variety of patterns. As a first example pattern, the impairments generally exhibit dynamic behavior during the initial minutes of device operation, followed by stabilization, although times vary among devices. As another example pattern, among the impairments, CFO and SCE undergo a relatively more significant variation (e.g., as compared to other metrics) during the warm-up phase, with notable changes from minute 1 to minute 12. For instance, the CFO for one device shifted from approximately 2300 Hz at the first minute to approximately −12000 Hz by the twelfth minute. Such drastic changes underscore sensitivity of the CFO metric to device warm-up effects, making it a potentially pivotal factor in the transient behavior of RF signals during this period. As another example pattern, the separability of impairments varies among respective devices, e.g., with CFO and SCE impairments standing out as most distinguishable by showcasing relatively larger differences in the values of these impairments among different devices (e.g., as compared to other metrics).

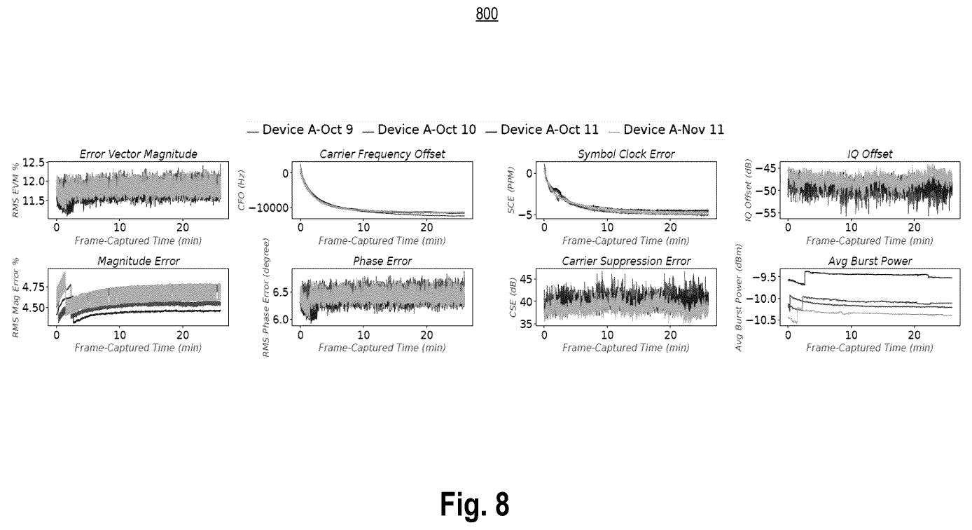

FIG. 8 illustrates diagrams 800 of example hardware impairments of an example device (e.g., labeled ‘Device A’) based on measurements collected on different days (e.g., labeled ‘October 9’, ‘October 10’, ‘October 11’, ‘November 11’). In the scenario of FIG. 8, system 600 (and/or 620) can be used to collect hardware impairment metrics of a particular device (e.g., device 604 or 624) on different days to evaluate the long-term behavior of the hardware impairments. As shown in FIG. 8, the hardware metrics seem to generally exhibit a consistent behavior across the four collection instances (e.g., on different days). These results may also indicate that once devices stabilize, their behavior may generally remain consistent over time. These results are also consistent with the evaluations discussed above, where the performance of DL models of FIGS. 5A-5B (trained on stable data then tested on warm-up data) was found to be less reliable than performance of DL models of FIGS. 4A-4B (trained on stable data and tested on stable data).

Based on the analysis of various hardware impairment metrics in the discussion above, a proposed scheme for an improved device fingerprinting system with resiliency to hardware warm-up will now be described in greater detail. In at least one embodiment, the proposed scheme involves training a machine learning model in a manner that leverages knowledge of hardware impairment behavior variability during and after device warm-up to improve robustness and accuracy of device identification/classification by the machine learning model.

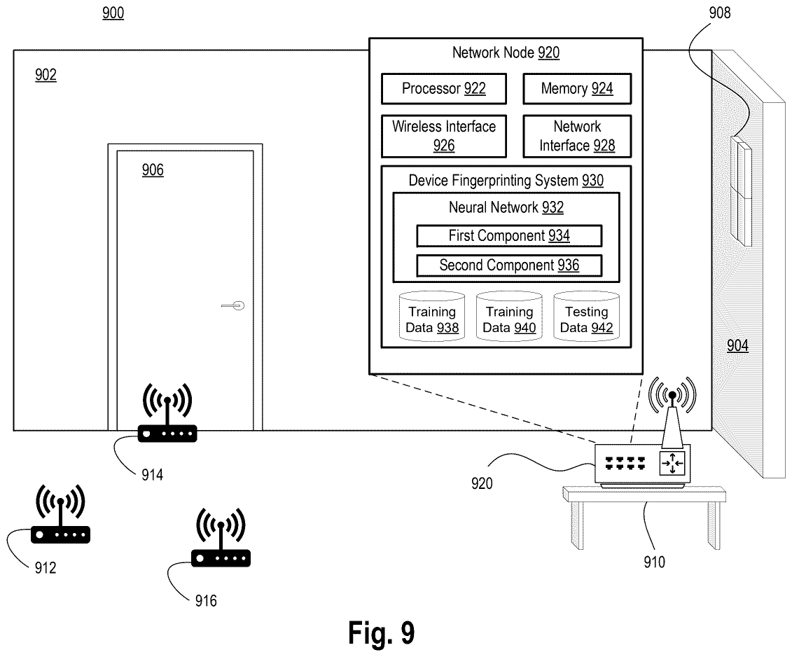

FIG. 9 illustrates an environment 900 in which an example network node device 920 implements an example device fingerprinting system 930 to identify one or more wireless devices 912, 914, and 916 positioned at different locations in environment 900, according to at least some embodiments. Environment 900 includes various objects and/or structures, such as walls 902 and 904, door 906, window 908, table 910, etc., which may influence (e.g., obstruct, reflect, scatter, etc.) RF paths of wireless signals transmitted between wireless devices 912, 914, and 916 and network node 920. For example, wireless signals transmitted from device 914 to network node 920 may be reflected, obstructed, etc., by one or more objects physically located between device 914 and network node 920, and so on.

Wireless devices 912, 914, and 916 include any wireless device that can sense and/or transmit data in the form of wireless signals (e.g., WiFi, 5G, etc.) to communicate with network node 920 and/or with other wireless devices. For example, a wireless device can be a computer, mobile phone, laptop, tablet, entertainment system, radio, IoT device (e.g., smart fridge, smart television, etc.), user equipment (UE), and/or any other type of device configured to wirelessly communicate with other devices. Although not shown, in at least one embodiment, system 900 additionally or alternatively includes one or more other devices (e.g., computers, etc.) connected to network node 920 and/or one or more of wireless devices 912, 914, and 916 via a wired connection (e.g., ethernet cable, etc.).

Network node 920 includes any computing system configured to communicate with wireless devices 912, 914, and 916, e.g., by receiving and decoding wireless signals transmitted from wireless devices 912, 914, and 916. To that end, network node 920 may be like and/or may implement one or more of the functionalities of any of computer system 252, SDR 254, and/or signal analyzers 602 and 622. In at least one embodiment, network node 920 is configured as a network access point (e.g., network router, network gateway, etc.) that facilitates, authenticates, and/or authorizes network connectivity (e.g., local area network, internet access, etc.) between wireless devices 912, 914, and 916 and/or to other network resources (e.g., internet, etc.). For example, network node 920 may include a base station or microcell (e.g., eNode-B (eNB)) or an edge device.

In the illustrated example, network node 920 includes a processor 922, a memory 924 coupled to the processor, a wireless interface 926, a network interface 928, and device fingerprinting system 930. Processor 922 includes one or more processors configured to execute machine-readable instructions stored in memory 924 to cause network node 920 to perform the various functions of disclosure. For example, processor 922 may include circuitry wired to perform these functions. To that end, memory 924 may include any type of non-transitory storage media (e.g., data storage) suitable for storing the machine-readable instructions. In at least some examples, memory 924 may also store weights associated with a machine learning model of device fingerprinting system 930 and/or other information needed to operate device fingerprinting system 930.

Wireless interface 926 includes any combination of hardware and/or software configured to receive wireless signals transmitted from wireless devices 912, 914, and 916 (and/or transmit wireless signals to the wireless devices). In at least one embodiment, wireless interface 926 also includes signal processing components configured to extract information from the incoming wireless signals. For example, wireless interface 926 may include circuitry configured to extract, from the incoming wireless signal, an RF burst in a time interval that corresponds to an individual data packet (e.g., WiFi packet) from a particular wireless device, determine an I/Q signal representation of the data packet, sample the I/Q signal, and/or provide the I/Q signal to device fingerprinting system 930.

Network interface 928 is optionally included in network node 920 and may include any combination of hardware and/or software configured to provide authorized connectivity to a remote network (e.g., the internet) to one or more of wireless devices 912, 914, and 916. For example, network node 920 may be configured as an access point that manages internet traffic or other network traffic between a remote network node (not shown) and one or more of wireless devices 912, 914, and 916. In this example, network interface 928 may communicate with the remote network node according to a particular network communication protocol (e.g., 5G network protocol, etc.), e.g., which may be different from the network protocol (e.g., WiFi network protocol, etc.) used by wireless interface 926 to interact with wireless devices 912, 914, and 916.

Device fingerprinting system 930 includes any combination of hardware and/or software configured to use an I/Q signal, corresponding to a data packet received from a wireless device, as input for a neural network 932 trained to predict or identify the wireless device (e.g., by outputting a device label) that transmitted the data packet. To that end, neural network 932 may include any type of deep-learning ML model (e.g., CNN) trained in accordance with the present disclosure to identify the wireless device reliably even if the data packet was transmitted by the wireless device during a warm-up phase of the wireless device, in line with the discussion above.

To facilitate this, as shown, neural network 932 includes a first component 934 and a second component 936. The first component includes one or more neural network layers (e.g., convolution layers, dense layers, etc.) that are pre-trained to estimate one or more hardware impairment metrics (based on input I/Q signals), such as any of the metrics depicted in FIG. 7, for instance. After the first component is trained, one or more additional neural network layers (e.g., dense layers, etc.) of the second component are then trained using features extracted by the pre-trained first component (e.g., without changing the pre-trained weights of the neurons in the first component). In this way, the training of the second component benefits from learned patterns of hardware impairments (indicated by the pre-trained features extracted by the first component) while learning patterns specific to the device that is to be classified.

Device fingerprinting system 930 also includes one or more training datasets, exemplified by datasets 938 and 940, and one or more testing datasets, exemplified by dataset 942. Datasets 938, 940, and 942 may include labeled data collected from wireless devices 912, 914, and 916. For example, datasets 938, 940, and 942 may include I/Q signals sampled for each time interval corresponding to a data packet (e.g., WiFi packet) and computed impairment metrics and/or device labels, similarly to the labeled data described above for FIG. 7.

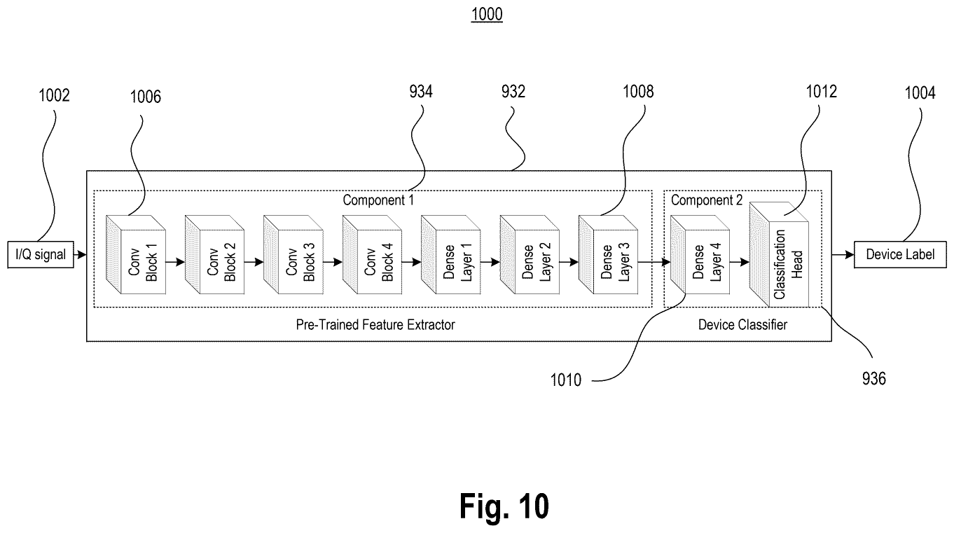

FIG. 10 illustrates a diagram of a machine learning model 1000 that can be used to perform device fingerprinting with resiliency to hardware warm-up by applying neural network 932 that includes first component 934 that implements a pre-trained feature extractor and second component 936 that implements a device classifier, according to at least some embodiments.

In other words, neural network 932 of device fingerprinting system 930 (which may be interchangeably referred to herein as ‘HEEDFUL’) implements two main components: a pretrained impairment estimator and a device classification head. In at least one embodiment, the proposed scheme may include training a deep single-input-multi-output CNN model, or leveraging a source dataset (e.g., I/Q signals and computed impairment metrics for a device during warm-up and stable phases, such as the data described for FIG. 7). For example, the source dataset comprises time-domain I/Q representations of Wi-Fi frames as input and encompasses eight hardware impairments as labels. Through rigorous training on this source task, ML model 1000 learns to concurrently and accurately estimate multiple impairments. Subsequently, the expertise of this pretrained impairment estimator (e.g., component 934) is harnessed as a feature extractor for the device classification model (e.g., component 936). This fusion, e.g., entails integration of the pretrained impairment estimator (e.g., component 934) with two additional dense layers (e.g., dense layer 1010 and Device Classification Head 1012). With this arrangement, a robust framework is formed (e.g., machine learning model 1000) for device classification. In particular, the proposed scheme involves training the second model (component 936) on the device classification task, e.g., using a different target dataset which features time-domain I/Q data as input and device labels as the output, without changing the learned weights of the pre-trained feature extractor (e.g., component 934). This strategic approach ensures that the combined model of neural network 934 excels at device classification, because it harnesses the knowledge learned from the preceding impairment estimation phase to create a robust and effective RF fingerprinting system.

In the illustrated example, neural network 932 receives I/Q signal 1002 as input and provides a device label 1004 (e.g., identification or prediction of wireless device associated with I/Q signal 1002) as an output. In at least one embodiment, I/Q signal 1002 includes a time-domain I/Q tensor with dimension of 2×17550 (e.g., 17550 samples of both I and Q signals corresponding to a data packet). The architecture of first component 934 (e.g., pre-trained feature extractor) comprises four Convolutional blocks, exemplified by convolutional block 1006). Each convolutional block may include a 2D convolutional layer followed by Rectified Linear activation units (ReLU) and a 2D max-pooling layer (e.g., 1×2 size with a stride of 1×2) to dimensionally reduce feature maps. In at least one embodiment, the convolutional layers in these blocks may employ filters of sizes 256, 128, 64, and 32, respectively. First component 934 also includes two dense layers (e.g., dense layer 1008, etc.) outputting 256 and 128 neurons respectively which are subsequently applied (e.g., after the convolutional blocks). In at least one embodiment, each dense layer may be followed by an ReLU activation layer.

In the illustrated example, second component 936 is trained using features extracted from first component 934 (e.g., output of dense layer 1008) using a second (different) dataset, which may be referred to herein as a target dataset. The target dataset includes I/Q signals together with a device label. During training of the model of second component 936, the pre-trained weights of first component 934 are not changed, e.g., only the dense layers of component 936 are updated during this training stage.

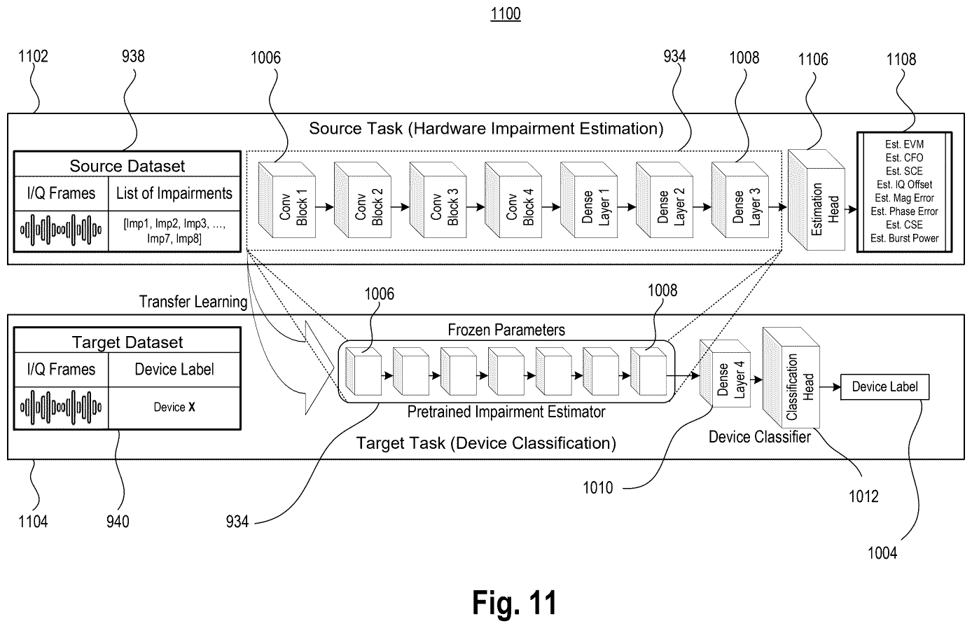

FIG. 11 illustrates a flowchart of an example process 1100 for sequential transfer learning of hardware impairment estimation to improve robustness of device classification, according to at least some embodiments.

Continuing with the example above, as shown in FIG. 11, after training first component 934 (source task 1102, training hardware impairment estimator) using source dataset, an output feature vector of dense layer 1008 is directed to an estimation head 1106, which generates a list of estimated impairments 1108 for each I/Q frame. In at least one embodiment, the model of first component 934 is optimized using Mean Square Error (MSE) and utilizes the Adaptive Estimation Momentum (Adem) optimizer with a learning rate of 0.0025, determined through experimental fine-tuning within the range [10⁻¹, 10⁻⁴]. With this arrangement, the convolutional layers and dense layers of first component 934 are trained to extract features that may indicate patterns corresponding to hardware impairments (without necessarily learning patterns that can identify a specific device).

Next, in this example, the pre-trained impairment estimator (excluding estimation head 1106) is used as a feature extractor to train second component 936 (e.g., target task 1104, training device classifier), which also involves using target dataset 940 (including device labels) as an input training dataset to train dense layer 1010 and classification layer 1012 without changing the pretrained parameters or weights of pretrained impairment estimator 934. In other words, following completion of training the impairment estimation model (e.g., source task 1102), the pretrained CNN model of component 934 is repurposed (e.g., by excluding estimation head 1106) as a feature extractor for device classification model (component 936) and/or tailored to target task 1104. For example, building upon impairment estimator 934, dense layer 1010 may include 256 neurons that transform the 128-size feature vector (output from dense layer 1008) and relays it to classification head 1012. In at least one embodiment, classification head 1012 incorporates a dense layer (not shown) with a SoftMax activation function responsible for determining radio classification probabilities. In at least embodiment, both the device classification model (e.g., component 936) and the impairment estimation network (e.g., component 934) may employ the same optimizer (e.g., with a cross-entropy loss function for the device classifier). In at least embodiment, both models may be trained using the Keras library on an NVIDIA Geforce RTX 2080 Ti GPU system with training extending over 20 epochs.

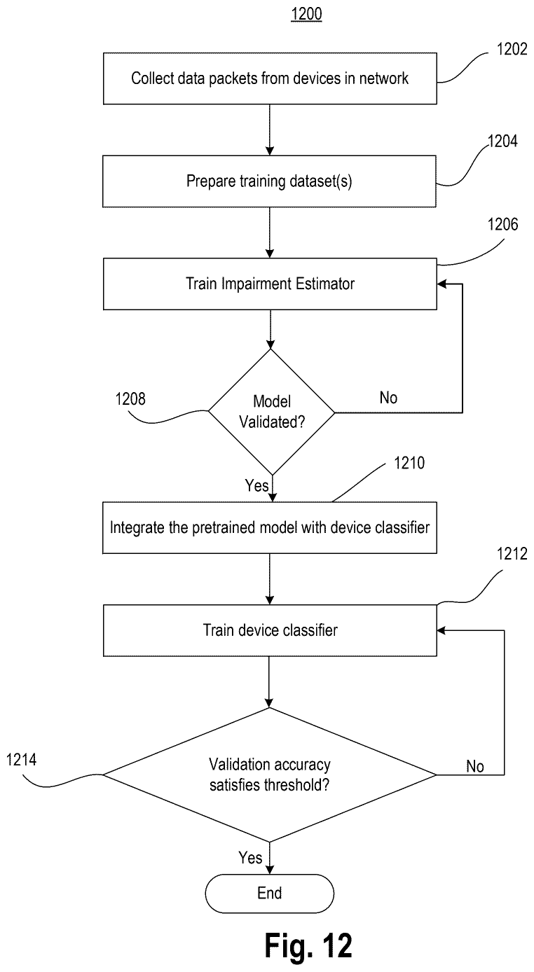

FIG. 12 illustrates a flowchart of a process 1200 for sequentially training a first component of an example neural network for estimating one or more hardware impairment metrics and using features extracted by the pre-trained first component as input for training a second component of the example neural network to classify devices with resiliency to hardware warm-up, according to at least some embodiments.

At 1202, process 1200 includes an example system (e.g., network node 920, device fingerprinting system 930, etc.) collecting data packets from devices in a (e.g., local) network. For example, network node 920 may instruct one or more of wireless devices 912, 914, and 916 to send a stream of wireless data packets (e.g., after a next start-up or activation event of the devices) in a specific manner (e.g., regular intervals, etc.) to allow the example system to generate one or more training datasets (e.g., training data 938, 940, etc.) and/or one or more testing datasets (e.g., testing data 942) for the wireless devices. For instance, network node 920 may instruct the wireless devices to collect data for the first 20-30 minutes after activation to capture data in both warm-up and stable phases of each device. This comprehensive collection facilitates preparing datasets that represent a full range of operational states, for instance.

At 1204, process 1200 includes the example system preparing one or more training datasets (e.g., training data 938, 940, etc.) based on the collected data packets. For instance, the example system may organize a dataset of the collected data from a device to include I/Q signals representing WiFi packets as input variables and hardware impairment metric measurements associated with these WiFi packets as target outcomes. The dataset may also be divided into a training dataset (e.g., source dataset 938) and a testing or validation dataset (e.g., training dataset 942) to support model training and performance evaluation.

At 1206, process 1200 includes the example system training an impairment estimator based on the training dataset(s). For example, the impairment estimator 934 can be trained in line with the discussion above using source dataset 938 to estimate impairment metrics 1108. In at least one embodiment, the example system trains the impairment estimator model to simultaneously estimate multiple impairments. In some scenarios, this simultaneous training can also improve robustness of the overall model at distinguishing between specific characteristics of each device.

At 1208, process 1200 includes the example system validating whether the impairment estimator model has been sufficiently trained. For example, the system may monitor error metrics during training. If the impairment estimator model achieves a satisfactory (e.g., threshold) accuracy, then the system may conclude the training, save the pre-trained model for later use, and proceed to block 1210. Otherwise, the example system continues training the impairment estimator model by repeating block 1206.

At block 1210, process 1200 includes the example system integrating the pretrained model with the device classifier. For example, as depicted in FIGS. 10 and 11, the pretrained impairment estimator 934 (e.g., excluding estimation head 1106) is used as a pre-trained feature extractor (e.g., by using the output of dense layer 1008 as input for the dense layer 1010 of device classifier 936). Thus, estimation head 1106 is removed from the pretrained impairment estimator model after source task 1102 is completed and integrated with the device classifier component 936 as shown in FIG. 11. After this modification, the focus of the model can now be shifted from impairment estimation to direct device classification.

At 1212, process 1200 includes the example system training the device classifier 936. For example, as shown in FIG. 11, the system may freeze the weights of the impairment estimator while target task 1104 (e.g., training the device classifier) is running to preserve the learned characteristics of the pretrained impairment estimator while training the dense layers of the device classifier using target dataset 940. Target dataset 940 includes I/Q frames as input variables and device labels as targeted outputs.

At 1214, process 1200 includes the example system validating whether the device classifier has been sufficiently trained and determining whether a validation accuracy satisfies a threshold accuracy. For example, the system may continue training device classifier 936 (e.g., by repeating step 1212) until it reaches a threshold level (e.g., high level) of accuracy at the task of classifying devices from input I/Q signals. Once the threshold accuracy is achieved, process 1200 ends.

In some examples, process 1200 also includes the example system (e.g., network node 920) applying a neural network 932 having a first component 934 and a second component 936. The first component of the neural network is trained for estimating one or more impairment metrics and the second component of the neural network is trained to classify a wireless device based at least in part on output from the first component (e.g., output of dense layer 1008) of the neural network.

In at least one embodiment, process 1200 also includes the example system receiving first information (e.g., WiFi data packets) from a first wireless device (e.g., wireless device 912), and identifying the first wireless device based on applying the neural network and using the first information. For example, network node 920 may identify that the first wireless device as device 912 by providing I/Q signals (e.g., I/Q signal 1002) corresponding to the first information as input to neural network 932 of device fingerprinting system 930, and then responsively receiving a device label (e.g., device label 1004) from neural network 932 that identifies device 912 as the first wireless device.

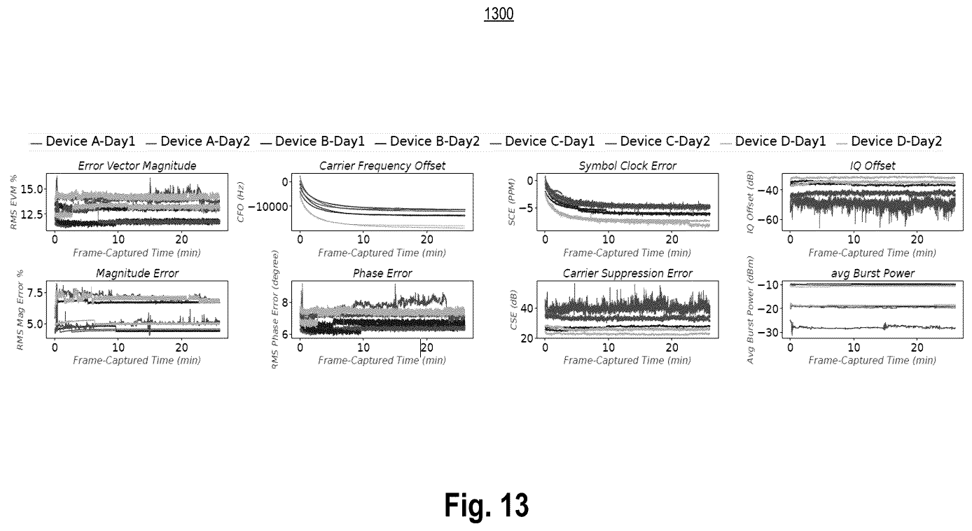

FIG. 13 illustrates diagrams 1300 of example hardware impairment metrics determined based on wireless data signals collected from a plurality of devices (e.g., labeled ‘Device A’, ‘Device B’, ‘Device C’, and ‘Device D’) during an initial thirty minutes of operation of the plurality of devices. In at least one embodiment, data fingerprinting system 930 and/or any of systems 600 and 620 can be used to collect the hardware impairment metrics shown for the four devices in the scenario of FIG. 13. The results show that even in a wireless setup devices performed reliably in CFO and CSE based systems during stable intervals but less reliably during warm-up intervals.

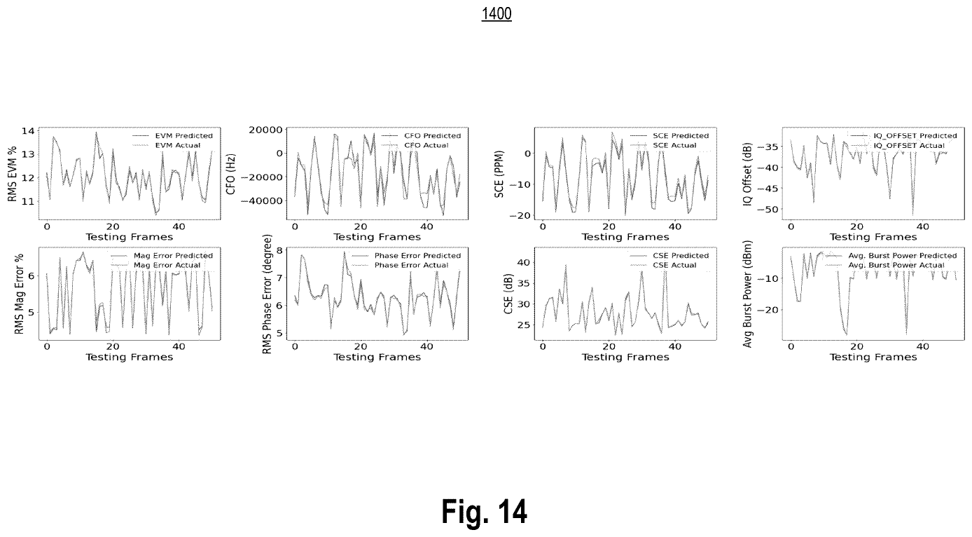

FIG. 14 illustrates diagrams 1400 showing estimated hardware impairment metrics of a plurality of different devices using an example impairment estimator of an example device fingerprinting device. For example, in the scenario of FIG. 14 the actual hardware impairment metrics (e.g., in testing data 942) are compared against estimated metrics 1108 to determine whether the impairment estimator has been sufficiently trained in source task 1102. In the scenario of FIG. 14, testing dataset 942 comprises 9,000 frames collected during the initial 30 minutes of device operation of 15 different devices. As shown in FIG. 14, the average Mean Absolute Error (MAE) for the concurrent estimation of eight distinct hardware impairments stands at a negligible 0.004. This result is visually affirmed in FIG. 14, where we observe an almost perfect overlap between predicted and actual impairment measurements for 50 randomly selected testing frames from the dataset, underscoring the capability of our network (e.g., neural network 932) to accurately map raw I/Q frames to their corresponding impairments. Estimation of different sets of impairments are presented below in Table 1. This rigorous evaluation reaffirms the robustness and precision of the impairment estimation model.

TABLE 1
Performance of Impairment Estimator

| # of | | |
|---|---|---|
| Impairments | List of Estimated Impairments | MAE |
| 8 | [evm, cfo, sce, iq offset, mag error, | 0.004 |
| | phase error, cse, burst power] | |
| 7 | [evm, cfo, sce, iq offset, mag error, | 0.004 |
| | phase error, cse] | |
| 6 | [evm, cfo, sce, iq offset, mag error, cse] | 0.004 |
| 5 | [evm, cfo, sce, iq offset, cse] | 0.004 |
| 4 | [evm, cfo, iq offset, cse] | 0.004 |
| 3 | [cfo, iq offset, cse] | 0.007 |
| 2 | [cfo, iq offset] | 0.007 |
| 1 | [cfo] | 0.0008 |

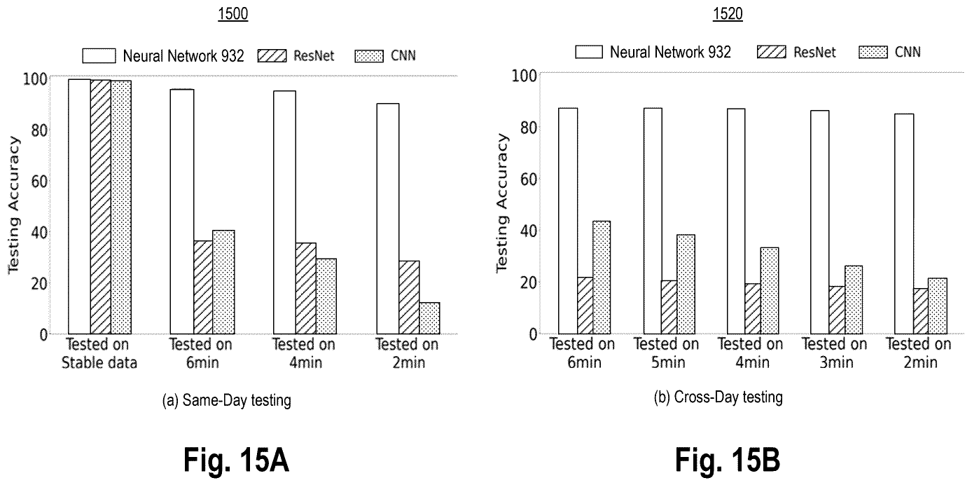

FIGS. 15A-15B illustrate diagrams 1500 and 1520 showing performance of an example device fingerprinting system (e.g., device fingerprinting system 930) with resiliency to hardware warm-up as compared to performance of other device fingerprinting systems. Diagrams 1500 and 1520 show the performance of neural network 932 (e.g., which was sequentially trained according to process 1200) against the performance of a traditional ResNet model and a traditional CNN model trained to classify devices without accounting for any specific hardware impairment metric.

In the scenario of FIG. 15A, same-day evaluations are conducted, where we train neural network 932 as well as traditional CNN and ResNet models using frames captured during the post-stabilization phase, and then test each model on frames captured during warm-up phases at 6, 4, and 2 minutes using a same day dataset. As depicted in FIG. 15A, all three models achieve near-perfect classification when tested with stable data. However, neural network 932 exhibits exceptional performance when tested with frames captured during warm-up, outperforming both the CNN and ResNet models across all testing intervals in the warm-up phase. For instance, when tested on frames captured within 6 minutes from device activation, neural network 932 of the proposed scheme achieves an accuracy of approximately 96%, whereas the ResNet and CNN models attain 64% and 40%, respectively. Even within the most unstable intervals (4-minute and 2-minute), neural network 932 maintains its excellence, achieving testing accuracies of 95% and 90%, respectively. In contrast, the ResNet and CNN models struggle to maintain the performance they had when tested with stable data, with testing accuracies plummeting to as low as 28% and 12% in the initial 2-minute interval.

In the scenario of FIG. 15B (cross-day testing), the three models are tested using frames collected on a different day (e.g., Day 2) than the day on which training data was collected (e.g., Day 1). In this example, the testing data is captured approximately two weeks after the training data was captured. As depicted in FIG. 15B, the results show that neural network 932 consistently maintains a high classification accuracy of approximately 87% across the warm-up intervals even when tested on the ‘Day 2’ dataset. In contrast, ResNet struggles to attain a classification accuracy above 20%. The plain CNN model had a highest classification accuracy of approximately 43% within the initial 6-minute interval, dropping to as low as 21% when tested against data from 2-minute intervals. The underwhelming performance of the CNN and ResNet benchmarks underscores the challenges of learning RF fingerprinting in a complex RF environment without guidance of domain knowledge (e.g., hardware impairment metrics). Thus, the consistent superior performance of the proposed scheme (neural network 932) represents a significant improvement over the CNN and ResNet models.

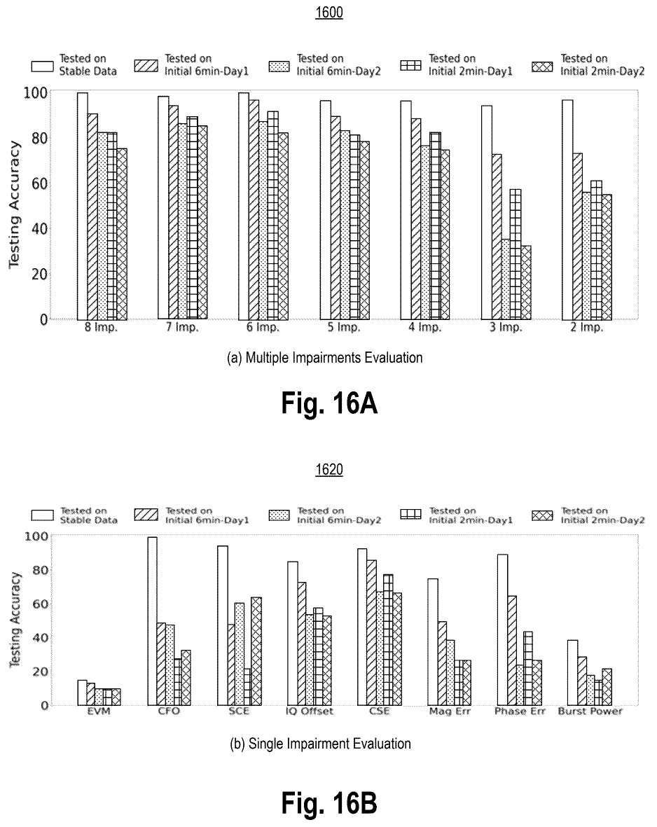

FIGS. 16A-B illustrate diagrams 1600 and 1620 evaluating performance of an example device fingerprinting system when pre-trained to estimate various possible combinations of multiple hardware impairment metrics simultaneously to improve device classification. In the scenario of FIGS. 16A-16B, the device fingerprinting system 930 is tested by training the impairment estimator using different combinations of hardware impairments (e.g., from the combinations shown in Table 1).

In the scenario of FIG. 16A, device fingerprinting system 930 exhibits consistent accuracy with different numbers of impairment-based estimators in post-stabilization captures, while accuracy variations emerged when testing the system using data from warm-up intervals. The multi-impairments evaluation, as depicted in FIG. 16A, highlights superior performance with 8, 7, and 6 impairment-based systems, but 3-impairment and 2-impairment-based systems struggled the most in the warm-up intervals. This underscores the advantage of providing a comprehensive knowledge of impairments to the classifier head. In some scenarios, different impairment selections may be helpful as well. For example, in the scenario of FIG. 16A, systems based on 7 and 6 impairments seemed to perform better than an 8-impairment-based system. This may be due to the inclusion of average burst of power in the 8-impairment-based system, which is a metric that varies different across datasets due to varied power sources. However, it is noted that in other scenarios, the 8-impairment-based system may perform better. Additionally, in this scenario, the 3-impairment-based system has lower accuracy results than the 2-impairment-based system within warm-up intervals. This may be due to two of the three impairments, CFO and SCE, displaying significant variance between stable and warm-up intervals.

In the scenario of FIG. 16B, single-impairment based impairment estimator fingerprinting system configurations are tested to assess the effectiveness of each single-impairment estimator configuration separately. In this scenario, CFO-based and CSE-based systems seemed to provide the highest device classification accuracy results (e.g., compared to other single-impairment-based configurations) when testing data is collected during stable phases but their testing results were much lower when testing data is collected during warm-up phases, both on same and different days. IQ-offset-based and CSE-based systems showed less accurate classification in the stable interval but exhibited more stable performance in warm-up intervals. EVM and Burst power-based systems demonstrated the poorest performance among single-impairment-based configurations.

In at least one embodiment, the hardware impairment estimator 934 is capable of simultaneously estimating multiple (e.g., eight, etc.) impairments with exceptional accuracy. This high-precision functionality enhances device authentication and is beneficial for other technological contexts, such as telecommunications and electronic manufacturing, making it a versatile tool in other applications in addition to security applications.

In at least one embodiment, the classification system (e.g., component 936) is built on a pretrained model that maps IQ radio signals to a comprehensive list of hardware impairments. With this arrangement, relevant impairment data is fully utilized in the classification process, e.g., providing a more complete representation to a decision making layer (e.g., device classifier 936). Furthermore, with this arrangement, the model is less likely to overlook potentially vital features, thereby enhancing accuracy and reliability of device identification.

In at least one embodiment, the proposed device fingerprinting system 930 excels at recognizes devices during the initial warm-up phase, a period that is typically challenging for RF fingerprinting due to signal instability. The proposed framework achieves high accuracy, as discussed above, during these early intervals while also maintaining consistent performance across different operational days, significantly outperforming existing techniques in both reliability and robustness.

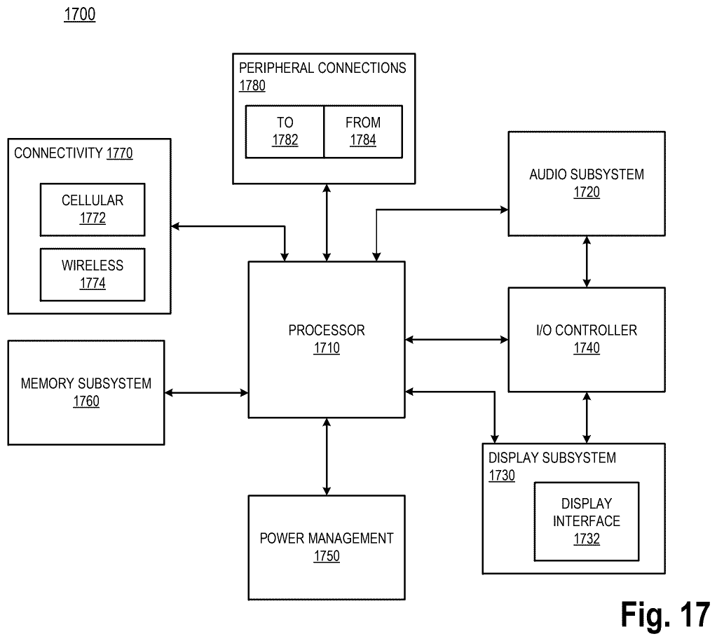

FIG. 17 illustrates a computer system 1700 having machine-readable media with instructions for executing the scheme of various embodiments. In some embodiments, computing device 1700 represents an appropriate computing device, such as a computing tablet, a mobile phone or smart-phone, a laptop, a desktop, an IOT device, a server, a set-top box, a wireless-enabled e-reader, or the like. It will be understood that certain components are shown generally, and not all components of such a device are shown in computing device 1700. In at least one embodiment, computer device 1700 implements network node 920 and/or device fingerprinting system 930.

In some embodiments, computing device 1700 includes processor 1710, audio subsystem 1720, display subsystem 1730, I/O controller 1740, power management 1750, memory subsystem 1760, connectivity 1770, and peripheral connections 1780.

In one embodiment, processor 1710 can include one or more physical devices, such as microprocessors, graphics processors, accelerators, inference logic, computational processor, application processors, microcontrollers, programmable logic devices, or other processing means. The processing operations performed by processor 1710 include the execution of an operating platform or operating system on which applications and/or device functions are executed. The processing operations include operations related to I/O (input/output) with a human user or with other devices, operations related to power management, and/or operations related to connecting computing device 1700 to another device. The processing operations may also include operations related to audio I/O and/or display I/O. In some embodiments, processor 1710 executes the scheme for identifying wireless devices by capturing out-of-band information in addition to in-band information from wireless devices for enabling accurate classification of wireless devices. Both the in-band and out-of-band spectrum emissions of the received signal are used to capture hardware signatures and features.

In some embodiments, computing device 1700 includes audio subsystem 1720, which represents hardware (e.g., audio hardware and audio circuits) and software (e.g., drivers, codecs) components associated with providing audio functions to the computing device. Devices for such functions can be integrated into computing device 1700 or connected to the computing device 1700. Audio functions can include speaker and/or headphone output, as well as microphone input. In some embodiments, a user interacts with computing device 1700 by providing audio commands that are received and processed by processor 1710.

Display subsystem 1730 represents hardware (e.g., display devices) and software (e.g., drivers) components that provide a visual and/or tactile display for a user to interact with computing device 1700. Display subsystem 1730 includes display interface 1732, which includes the particular screen or hardware device used to provide a display to a user. In one embodiment, display interface 1732 includes logic separate from processor 1710 to perform at least some processing related to the display. In one embodiment, display subsystem 1730 includes a touch screen (or touch pad) device that provides both output and input to a user.

I/O controller 1740 represents hardware devices and software components related to interaction with a user. I/O controller 1740 is operable to manage hardware that is part of audio subsystem 1720 and/or display subsystem 1730. Additionally, I/O controller 1740 illustrates a connection point for additional devices that connect to computing device 1700 through which a user might interact with the system. For example, devices that can be attached to the computing device 1700 might include microphone devices, speaker or stereo systems, video systems or other display devices, keyboard or keypad devices, or other I/O devices for use with specific applications such as card readers or other devices.

As mentioned above, I/O controller 1340 can interact with audio subsystem 1320 and/or display subsystem 1730. For example, input through a microphone or other audio device can provide input or commands for one or more applications or functions of computing device 1700. Additionally, audio output can be provided instead of, or in addition to, display output. In another example, if display subsystem 1730 includes a touch screen, the display device also acts as an input device, which can be at least partially managed by I/O controller 1340. There can also be additional buttons or switches on computing device 1700 to provide I/O functions managed by I/O controller 1740.

In at least one embodiment, I/O controller 1740 manages devices such as accelerometers, cameras, light sensors, or other environmental sensors, or other hardware that can be included in computing device 1700. The input can be part of direct user interaction, as well as providing environmental input to the system to influence its operations (such as filtering for noise, adjusting displays for brightness detection, applying a flash for a camera, or other features).

In at least one embodiment, computing device 1700 includes power management 1750 that manages battery power usage, charging of the battery, and features related to power saving operation. In some embodiments, a power management system 1750 controls the power consumption of processor 1710. For example, power management system 1750 can clock gate, power gate, or apply any other power management techniques.

In at least one embodiment, memory subsystem 1760 includes memory devices for storing information in computing device 1700. Memory can include nonvolatile (state does not change if power to the memory device is interrupted) and/or volatile (state is indeterminate if power to the memory device is interrupted) memory devices. Examples of nonvolatile memory include flash memory, magnetic memory, and resistive memory. Examples of volatile memory include static random-access memory, dynamic random-access memory, etc. Memory subsystem 1760 can store application data, user data, music, photos, documents, or other data, as well as system data (whether long-term or temporary) related to the execution of the applications and functions of computing device 1700.

Elements of embodiments are also provided as a machine-readable medium (e.g., memory 1760) for storing the computer-executable instructions (e.g., instructions to implement any other processes discussed herein). The machine-readable medium (e.g., memory 1760) may include, but is not limited to, flash memory, optical disks, CD-ROMs, DVD ROMs, RAMS, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

The various embodiments of the present disclosure may also comprise a network interface within 1770 such as a wireless interface so that a system embodiment may be incorporated into a wireless device, for example, a cell phone or a personal digital assistant. Connectivity 1770 includes hardware devices (e.g., wireless and/or wired connectors and communication hardware) and software components (e.g., drivers, protocol stacks) to enable computing device 1700 to communicate with external devices. Computing device 1700 could be separate devices, such as other computing devices, wireless access points or base stations, as well as peripherals such as headsets, printers, or other devices.

Connectivity 1770 can include multiple different types of connectivity. To generalize, computing device 1700 is illustrated with cellular connectivity 1772 and wireless connectivity 1774. Cellular connectivity 1772 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, or other cellular service standards. Wireless connectivity (or wireless interface) 1774 refers to wireless connectivity that is not cellular and can include personal area networks (such as Bluetooth, Near Field, etc.), local area networks (such as Wi-Fi), and/or wide area networks (such as LTE), or other wireless communication.

Peripheral connections 1780 include hardware interfaces and connectors, as well as software components (e.g., drivers, protocol stacks) to make peripheral connections. It is understood that computing device 1700 could both be a peripheral device (“to” 1782) to other computing devices, as well as have peripheral devices (“from” 1784) connected to it. Computing device 1700 commonly has a “docking” connector to connect to other computing devices for purposes such as managing (e.g., downloading and/or uploading, changing, and synchronizing) content on computing device 1700. Additionally, a docking connector can allow computing device 1700 to connect to certain peripherals that allow computing device 1700 to control content output to audiovisual or other systems.

In addition to a proprietary docking connector or other proprietary connection hardware, computing device 1700 can make peripheral connections 1780 via common or standards-based connectors. Common types can include a Universal Serial Bus (USB) connector (which can include any of a number of different hardware interfaces), DisplayPort including MiniDisplayPort (MDP), High-Definition Multimedia Interface (HDMI), Firewire, Thunderbolt, or other types.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art considering the foregoing description. The embodiments of the disclosure are intended to embrace all such alternatives, modifications, and variations as to fall within the broad scope of the appended claims. Where specific details are set forth to describe example embodiments of the disclosure, it should be apparent to one skilled in the art that the disclosure can be practiced without, or with variation of, these specific details. The description is thus to be regarded as illustrative instead of limiting.

The following examples pertain to further embodiments. Specifics in the examples may be used anywhere in one or more embodiments. All optional features of the apparatus described herein may also be implemented with respect to a method or process. The examples can be combined in any suitable manner.

Example 1: a non-transitory machine-readable storage medium storing machine-readable instructions that, when executed, causes one or more machines to perform a method comprising: applying a neural network having a first component and a second component, wherein the first component of the neural network is trained for estimating one or more impairment metrics, wherein the second component of the neural network is trained to classify a wireless device based at least in part on output from the first component of the neural network; receiving first information from a first wireless device; and identifying the first wireless device based on applying the neural network and using the first information.

Example 2: The non-transitory machine-readable storage medium of example 1, wherein the neural network is sequentially trained by training the second component of the neural network after the first component of the neural network is trained.

Example 3: The non-transitory machine-readable storage medium of example 1, wherein the first component of the neural network is trained using first training data and the second component of the neural network is trained using second training data different than the first training data.

Example 4: The non-transitory machine-readable storage medium of example 1, wherein the one or more impairment metrics include at least one of: an error vector magnitude (EVM), a magnitude error, a phase error, an in-phase/quadrature (IQ) offset, a carrier frequency offset (CFO), a symbol clock error (SCE), a carrier suppression error (CSE), or an average burst power.

Example 5: The non-transitory machine-readable storage medium of example 1, the method further comprising: collecting data packets including the first information from a plurality of wireless devices; and generating, based on the collected data packets, first training data for training an impairment estimator, second training data for training a device classifier, and third training data for validating the training of the impairment estimator and the device classifier.

Example 6: The non-transitory machine-readable storage medium of example 1, the method further comprising: training, as the first component, a first machine learning model of an impairment estimator based on first training data to estimate the one or more impairment metrics; integrating a second machine learning model of a device classifier with the trained first machine learning model; and training, as the second component, the second machine learning model of the device classifier based on second training data to classify the wireless device.

Example 7: The non-transitory machine-readable storage medium of example 6, the method further comprising: training the first machine learning model by determining first weights for the first machine learning model; and training the second machine learning model by determining second weights for the second machine learning model without changing the first weights of the first machine learning model.

Example 8: A network node comprising: a processor; a memory coupled to the processor, wherein the memory stores instructions that, when executed by the processor, cause the network node to perform a method comprising: applying a neural network having a first component and a second component, wherein the first component of the neural network is trained for estimating one or more impairment metrics, wherein the second component of the neural network is trained to classify a wireless device based at least in part on output from the first component of the neural network; receiving first information from a first wireless device; and identifying the first wireless device based on applying the neural network and using the first information.

Example 9: The network node of example 8, wherein the neural network is sequentially trained by training the second component of the neural network after the first component of the neural network is trained.

Example 10: The network node of example 8, wherein the first component of the neural network is trained using first training data and the second component of the neural network is trained using second training data different than the first training data.

Example 11: The network node of example 8, wherein the one or more impairment metrics include at least one of: an error vector magnitude (EVM), a magnitude error, a phase error, an in-phase/quadrature (IQ) offset, a carrier frequency offset (CFO), a symbol clock error (SCE), a carrier suppression error (CSE), or an average burst power.

Example 12: The network node of example 8, the method further comprising: collecting data packets including the first information from a plurality of wireless devices; and generating, based on the collected data packets, first training data for training an impairment estimator, second training data for training a device classifier, and third training data for validating the training of the impairment estimator and the device classifier.

Example 13: The network node of example 8, the method further comprising training, as the first component, a first machine learning model of an impairment estimator based on first training data to estimate the one or more impairment metrics; integrating a second machine learning model of a device classifier with the trained first machine learning model; and training, as the second component, the second machine learning model of the device classifier based on second training data to classify the wireless device.

Example 14: The network node of example 13, the method further comprising: training the first machine learning model by determining first weights for the first machine learning model; and training the second machine learning model by determining second weights for the second machine learning model without changing the first weights of the first machine learning model.

Example 15: A method comprising: applying a neural network having a first component and a second component, wherein the first component of the neural network is trained for estimating one or more impairment metrics, wherein the second component of the neural network is trained to classify a wireless device based at least in part on output from the first component of the neural network; receiving first information from a first wireless device; and identifying the first wireless device based on applying the neural network and using the first information.

Example 16: The method of example 15, wherein the neural network is sequentially trained by training the second component of the neural network after the first component of the neural network is trained.

Example 17: The method of example 15, wherein the first component of the neural network is trained using first training data and the second component of the neural network is trained using second training data different than the first training data.

Example 18: The method of example 15, wherein the one or more impairment metrics include at least one of: an error vector magnitude (EVM), a magnitude error, a phase error, an in-phase/quadrature (IQ) offset, a carrier frequency offset (CFO), a symbol clock error (SCE), a carrier suppression error (CSE), or an average burst power.

Example 19: The method of example 15, further comprising: collecting data packets including the first information from a plurality of wireless devices; and generating, based on the collected data packets, first training data for training an impairment estimator, second training data for training a device classifier, and third training data for validating the training of the impairment estimator and the device classifier.

Example 20: The method of example 15, further comprising: training, as the first component, a first machine learning model of an impairment estimator based on first training data to estimate the one or more impairment metrics; integrating a second machine learning model of a device classifier with the trained first machine learning model; and training, as the second component, the second machine learning model of the device classifier based on second training data to classify the wireless device.

What is claimed is:

1. A non-transitory machine-readable storage medium storing machine-readable instructions that, when executed, causes one or more machines to perform a method comprising:
applying a neural network having a first component and a second component, wherein the first component of the neural network is trained for estimating one or more impairment metrics, wherein the second component of the neural network is trained to classify a wireless device based at least in part on output from the first component of the neural network;
receiving first information from a first wireless device; and
identifying the first wireless device based on applying the neural network and using the first information.

2. The non-transitory machine-readable storage medium of claim 1, wherein the neural network is sequentially trained by training the second component of the neural network after the first component of the neural network is trained.

3. The non-transitory machine-readable storage medium of claim 1, wherein the first component of the neural network is trained using first training data and the second component of the neural network is trained using second training data different than the first training data.

4. The non-transitory machine-readable storage medium of claim 1, wherein the one or more impairment metrics include at least one of: an error vector magnitude (EVM), a magnitude error, a phase error, an in-phase/quadrature (IQ) offset, a carrier frequency offset (CFO), a symbol clock error (SCE), a carrier suppression error (CSE), or an average burst power.

5. The non-transitory machine-readable storage medium of claim 1, the method further comprising:
collecting data packets including the first information from a plurality of wireless devices; and
generating, based on the collected data packets, first training data for training an impairment estimator, second training data for training a device classifier, and third training data for validating the training of the impairment estimator and the device classifier.

6. The non-transitory machine-readable storage medium of claim 1, the method further comprising:
training, as the first component, a first machine learning model of an impairment estimator based on first training data to estimate the one or more impairment metrics;
integrating a second machine learning model of a device classifier with the trained first machine learning model; and
training, as the second component, the second machine learning model of the device classifier based on second training data to classify the wireless device.

7. The non-transitory machine-readable storage medium of claim 6, the method further comprising:
training the first machine learning model by determining first weights for the first machine learning model; and
training the second machine learning model by determining second weights for the second machine learning model without changing the first weights of the first machine learning model.

8. A network node comprising:
a processor; and
a memory coupled to the processor, wherein the memory stores instructions that, when executed by the processor, cause the network node to perform a method comprising:
applying a neural network having a first component and a second component, wherein the first component of the neural network is trained for estimating one or more impairment metrics, wherein the second component of the neural network is trained to classify a wireless device based at least in part on output from the first component of the neural network;
receiving first information from a first wireless device; and
identifying the first wireless device based on applying the neural network and using the first information.

9. The network node of claim 8, wherein the neural network is sequentially trained by training the second component of the neural network after the first component of the neural network is trained.

10. The network node of claim 8, wherein the first component of the neural network is trained using first training data and the second component of the neural network is trained using second training data different than the first training data.

11. The network node of claim 8, wherein the one or more impairment metrics include at least one of: an error vector magnitude (EVM), a magnitude error, a phase error, an in-phase/quadrature (IQ) offset, a carrier frequency offset (CFO), a symbol clock error (SCE), a carrier suppression error (CSE), or an average burst power.

12. The network node of claim 8, the method further comprising:
collecting data packets including the first information from a plurality of wireless devices; and
generating, based on the collected data packets, first training data for training an impairment estimator, second training data for training a device classifier, and third training data for validating the training of the impairment estimator and the device classifier.

13. The network node of claim 8, the method further comprising:
training, as the first component, a first machine learning model of an impairment estimator based on first training data to estimate the one or more impairment metrics;
integrating a second machine learning model of a device classifier with the trained first machine learning model; and
training, as the second component, the second machine learning model of the device classifier based on second training data to classify the wireless device.

14. The network node of claim 13, the method further comprising:
training the first machine learning model by determining first weights for the first machine learning model; and
training the second machine learning model by determining second weights for the second machine learning model without changing the first weights of the first machine learning model.

15. A method comprising:
applying a neural network having a first component and a second component, wherein the first component of the neural network is trained for estimating one or more impairment metrics, wherein the second component of the neural network is trained to classify a wireless device based at least in part on output from the first component of the neural network;
receiving first information from a first wireless device; and
identifying the first wireless device based on applying the neural network and using the first information.

16. The method of claim 15, wherein the neural network is sequentially trained by training the second component of the neural network after the first component of the neural network is trained.

17. The method of claim 15, wherein the first component of the neural network is trained using first training data and the second component of the neural network is trained using second training data different than the first training data.

18. The method of claim 15, wherein the one or more impairment metrics include at least one of: an error vector magnitude (EVM), a magnitude error, a phase error, an in-phase/quadrature (IQ) offset, a carrier frequency offset (CFO), a symbol clock error (SCE), a carrier suppression error (CSE), or an average burst power.

19. The method of claim 15, further comprising:
collecting data packets including the first information from a plurality of wireless devices; and
generating, based on the collected data packets, first training data for training an impairment estimator, second training data for training a device classifier, and third training data for validating the training of the impairment estimator and the device classifier.

20. The method of claim 15, further comprising:
training, as the first component, a first machine learning model of an impairment estimator based on first training data to estimate the one or more impairment metrics;
integrating a second machine learning model of a device classifier with the trained first machine learning model; and
training, as the second component, the second machine learning model of the device classifier based on second training data to classify the wireless device.
